(19) United States
(12) Patent Application Publication
(10) Pub. No.: US 2026/0073816 A1
(43) Pub. Date: Mar. 12, 2026

(54) IMPACT-RESISTANT AND FLEXIBLE SIGN MOUNT

(71) Applicant: Exit Sign Solutions, Inc., Pittsford, NY (US)

(72) Inventors: John William Field, Pittsford, NY (US); Conner Donnelly, Powhatan, VA (US); Thomas Eichler, Arlington, VA (US); Angel Hernandez, Peachtree City, GA (US)

(21) Appl. No.: 19/262,798

(22) Filed: Jul. 8, 2025

Related U.S. Application Data
(60) Provisional application No. 63/668,740, filed on Jul. 8, 2024.

(51) Int. Cl. G09F 7/22; G09F 7/18; G09F 13/04

(52) U.S. Cl. CPC G09F 7/22; G09F 13/04; G09F 2007/186; G09F 2013/05

(57) ABSTRACT

A mount for an exit sign or similar signage is provided. The mount includes a backplate to be fixed to a surface such as an electrical junction box in a ceiling and a base plate connected to the backplate, with matching pass-through holes to allow for electrical connections. A fin is fixed between the backplate and the base plate and is adapted to receive a sliding mount, the sliding mount. A conduit component provides for a flexible conduit for electrical wires from the junction box to a sign mounted to the mount. The mount system allows for deflection of the sign resulting from an impact or strike, with little or no damage to the sign.

### CROSS-REFERENCE TO RELATED APPLICATIONS

This application is a non-provisional of, and claims the priority benefit of U.S. Provisional Application No. 63/668,740, filed Jul. 8, 2024, the disclosure of which is incorporated by reference in its entirety for all purposes.

### FIELD

The present disclosure relates to emergency lighting, and in particular devices and techniques to provide emergency lighting and signage, including exit signs that are resilient to shocks such as those caused by vandalism.

### BACKGROUND

Emergency lighting, its electrical components, and its mounting canopy are critical components of building safety systems designed to ensure the safe evacuation of occupants during emergencies such as fires, power failures, or other situations where normal lighting is compromised. These systems are also necessary for compliance with building codes and standards, as well as for protecting the lives of building occupants. Emergency lighting serves the primary purpose of providing illumination during power outages or emergencies, ensuring that occupants can safely exit a building. Emergency lighting systems typically consist of illuminated exit signs, emergency lights, and backup power sources. For example, exit signs are required in all buildings in which a path to exit is not immediately apparent, per fire code regulations.

Emergency lighting and exit sign mounts play a critical role in building safety and emergency preparedness. These systems provide essential guidance and illumination during evacuations, helping to save lives in emergency situations. Compliance with regulations and proper maintenance are essential to ensure the effectiveness of these systems.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like.

FIG. 1A shows an example of an exit sign and mount as disclosed herein.

FIG. 1B shows an example of an exit sign and mount as disclosed herein.

FIG. 2 shows an example base plate according to embodiments disclosed herein.

FIG. 3 shows an example fin according to embodiments disclosed herein.

FIG. 4 shows an example of a conduit component according to embodiments disclosed herein.

FIG. 5 shows an example of a backplate according to embodiments disclosed herein.

FIG. 6 shows an example of a backplate according to embodiments disclosed herein.

FIG. 7 shows a sliding mount according to embodiments disclosed herein.

FIG. 8 shows a sliding mount according to embodiments disclosed herein.

FIG. 9A shows an example of an assembled mount according to embodiments disclosed herein.

FIG. 9B shows an example of a partially disassembled mount in which the sliding mount is detached from the rest of the assembly according to embodiments disclosed herein.

FIG. 10 shows an example of a fin configured to allow the installed system to twist according to embodiments disclosed herein.

FIG. 11 shows a backplate configured for use with the fin shown in FIG. 10 according to embodiments disclosed herein.

FIG. 12 shows a base configured for use with the fin shown in FIG. 10 according to embodiments disclosed herein.

FIG. 13 shows a graph of displacement over time experienced by a sign according to embodiments disclosed herein after being struck.

FIG. 14 shows the acceleration over time experienced by a sign according to embodiments disclosed herein after being struck.

FIG. 15 shows the magnitude of the momentum of a sign according to embodiments disclosed herein after being struck.

FIGS. 16 and 17A-B show the deflection angle over time for the same strike as in FIG. 15 according to embodiments disclosed herein.

FIG. 18 shows angular displacement over time for an ESS mount with a 0.061 in conduit as disclosed herein during a strike test.

FIG. 19 shows angular displacement over time for an ESS mount with a 0.061 in conduit as disclosed herein during a strike test.

FIG. 20 shows angular displacement over time for an ESS mount with a 0.061 in conduit as disclosed herein during a strike test.

FIG. 21 shows angular displacement over time for an ESS mount with a 0.061 in conduit as disclosed herein during a strike test.

FIG. 22 shows angular displacement over time for an ESS mount with a 0.071 in conduit as disclosed herein during a strike test.

FIG. 23 shows angular displacement over time for an ESS mount with a 0.071 in conduit as disclosed herein during a strike test.

FIG. 24 shows angular displacement over time for an ESS mount with a 0.071 in conduit as disclosed herein during a strike test.

FIG. 25 shows angular displacement over time for an ESS mount with a 0.071 in conduit as disclosed herein during a strike test.

FIG. 26 shows angular displacement over time for a conventional swing sign mount during a strike test.

FIG. 27 shows angular displacement over time for a conventional swing sign mount during a strike test.

FIG. 28 shows angular displacement over time for a conventional swing sign mount during a strike test.

FIG. 29 shows angular displacement over time for a conventional swing sign mount during a strike test.

FIG. 30 shows results of the tests performed on two versions of the ESS mount and the Swing mount during the same tests for which data is shown in FIGS. 18-29.

### DETAILED DESCRIPTION

Embodiments disclosed herein relate to emergency exit signs in buildings, such as college dormitories, high schools, and other high abuse areas, and include features that provide enhanced durability of such emergency exit signs while protecting the ceiling to which they are connected while maintaining an economical design.

Emergency exit signs can be mounted through either the side, the back, or the ceiling. The most common type of exit sign mount is a ceiling mount, some form of which is available for almost all conventional signs. This ceiling mount typically is a direct connection between the electrical junction box and the sign itself. The mounts also provide a path for the wiring from the ceiling to connect with the electrical components of the sign, in particular, a battery, transformer, and printed circuit board. Exit sign mounts typically are made of durable materials, such as metal or plastic, to ensure longevity and resistance to environmental factors. Despite this, conventional sign mounts that are not specifically resistant to vandalism do not prevent the exit signs from easily breaking due to small impacts, as well as causing damage to the portion of the ceiling to which they are mounted.

Regular testing and maintenance of emergency lighting systems, including exit signs, are essential to ensure they function correctly when needed. This includes periodic battery tests and inspections. If a sign is broken, not only is it a safety hazard, but it will need to be replaced to pass inspection. Absent vandalism and the like, exit signs generally last 5-10 years before their LEDs die, and the sign must be replaced.

Conventional exit signs, such as those often found in college dorms, high schools, and similar areas, are not sufficiently durable or resilient to survive shocks such as vandalism. When a sign is vandalized, it becomes inoperable and thereby unable to function properly in emergency situations until it is replaced. Further, vandalized signs render a building non-compliant with relevant safety codes, exposing the building management to potential fines from civil authorities. What is needed is a more resilient exit sign that continues to function after attempts to vandalize the sign or otherwise render it inoperable.

Some conventional exit signs are designed with several features meant to improve lifespan or prevent vandalism. Such designs include, for example, flexible solutions in photoluminescent signs, and durable solutions in vandal-proof signs. While some of these solutions may be viable, they are often too expensive to be widely implemented in environments such as university dorms and high schools, and create other problems such as ceiling damage under impact.

One of the primary challenges of meeting fire code requirements in high abuse areas is preventing the destruction of exit signs by students. Not only does such damage or destruction lead to frequent replacement costs, but it also causes several safety hazards. Signs that don't get fully destroyed from impact often lose their face plates, no longer displaying “EXIT” and exposing the internal electrical components of the sign. Some of these hazards include, but are not limited to, not being able to find an exit in the event of an emergency, exposed wires hanging down from the ceiling that could potentially lead to electric shock, and insufficient lighting in hallways in the event of a power outage. The signs that are used by most institutions are inexpensive, but also extremely breakable. Replacing signs frequently in order to maintain the building safety is inconvenient, inefficient, and expensive. A balance between durability and cost is required to be sustainable in high-risk and similar environments.

Embodiments presented herein address these and other shortcomings of conventional exit and similar signage by providing an innovative mount that connects directly to the junction box, and that can click into place with any generic exit sign. This mount can include parts that are mechanically connected to increase the durability of the sign by allowing for impact and torque without causing permanent damage to the sign or the ceiling area to which it is mounted, and without causing the sign to become dismounted. It incorporates the use of flexible and stiff polymers to absorb force and restore the sign to its original position after impact, and to maximize the strength of the mount while minimizing the cost. Embodiments disclosed herein also address the issue of faceplates easily falling from the sign under weak impacts.

Embodiments disclosed herein may be installed into the ceiling to comply with UL, NFPA, and all Fire Code requirements. Some of the issues addressed in the disclosed design include reducing the time, complexity, and cost of repairs, preventing faceplates from falling off under light or hard impact, and preventing damage to the exit sign and the ceiling to which it is attached. The design of the mount can prevent faceplates from falling off. The mount arrangement disclosed herein takes advantage of flexible polymers to absorb force and return the sign to its original position under heavy impact.

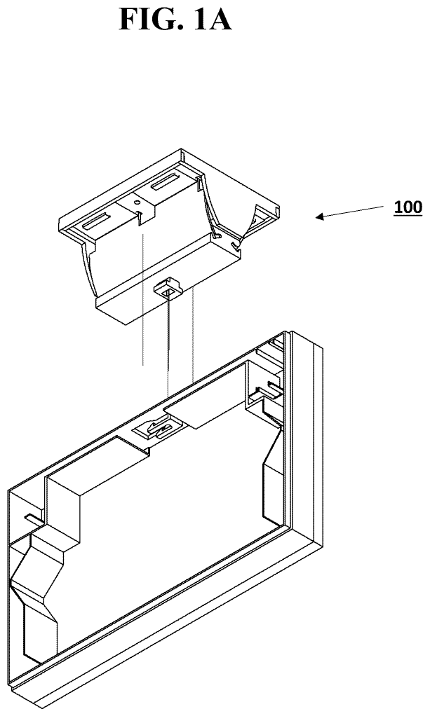

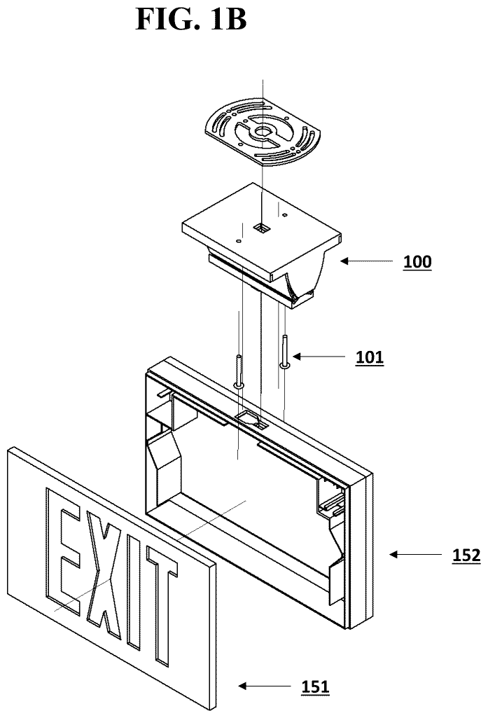

FIGS. 1A and 1B show examples of an exit sign and mount as disclosed herein. The mount 100 includes multiple components that may be connected as disclosed below, to provide the resiliency features disclosed herein. The exit sign (or other similar sign) may be connected to the mount via mounting screws or similar connectors as shown and as disclosed in further detail herein. FIG. 1B shows an exit sign including a front plate 151 and housing 152, attached to a mount 100 as disclosed herein. The mount 100 may be secured to a conventional mounting plate, junction box, or the like, for example via mounting screws 101 fed through the mount 100 to the mounting plate or other mount location.

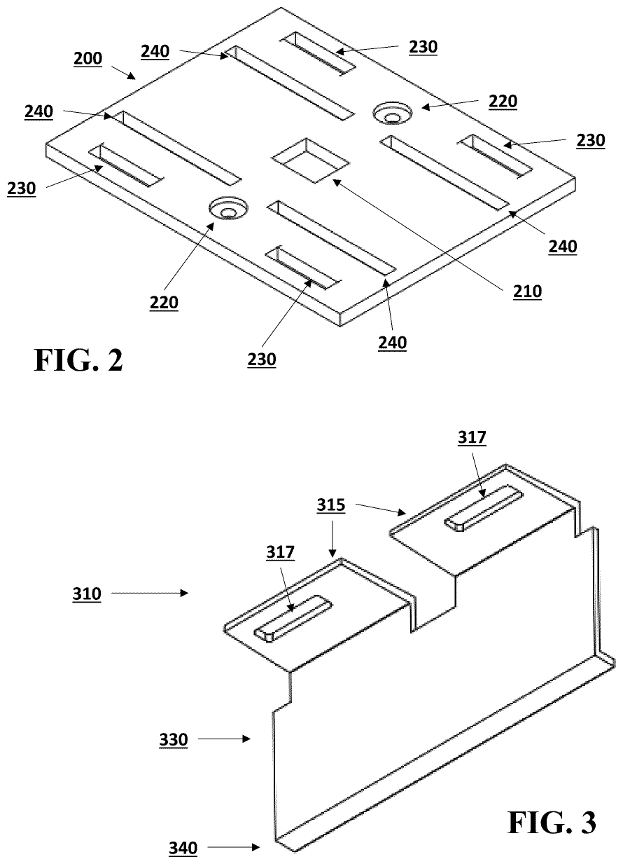

FIG. 2 shows an example base plate according to embodiments disclosed herein. The base plate 200 is generally flat and relatively thin and provides mounting connections for other components disclosed herein. The base plate includes a central wiring hole 210 to allow electrical wires to be fed through to the sign, for example from a junction box arranged in a ceiling to which the sign is mounted. The central hole 210 also allows the conduit 400 shown in FIG. 4 to be fed through, and may vary in size. Two collinear screw holes 220 may be arranged on either side of the wiring hole 210 to match with standard ceiling bracket screw hole placement and dimensions. These two holes 220 may be used to hold the system into the ceiling. On the corners of the base, anchor holes 230 allow connection with the backplate and fin components of the system as disclosed in further detail herein. Fin connection holes 240 are adjacent and parallel to the anchor holes 230, the functionality of which is disclosed in further detail below. The base plate 200 component may be made of rigid material such as ABS. Screws can be fed through the screw holes on the base and the backplate, then a mounting bracket to eventually be mounted to a junction box.

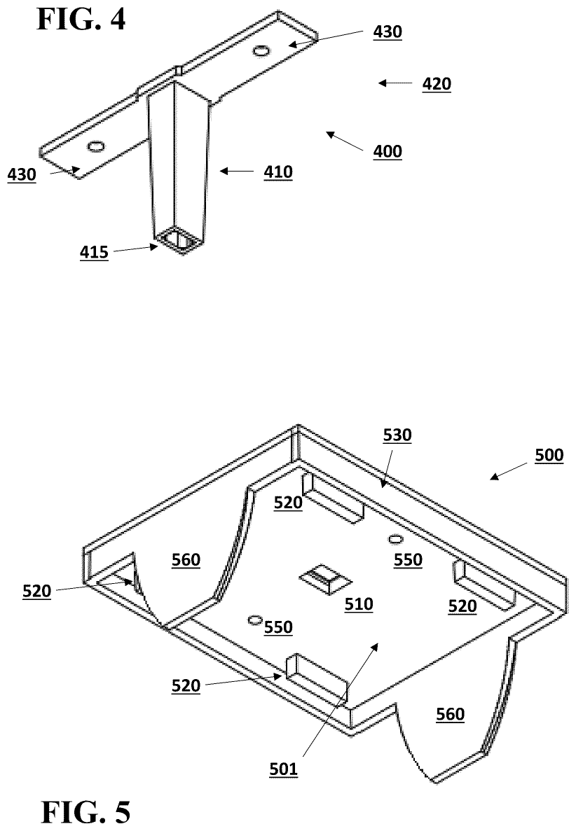

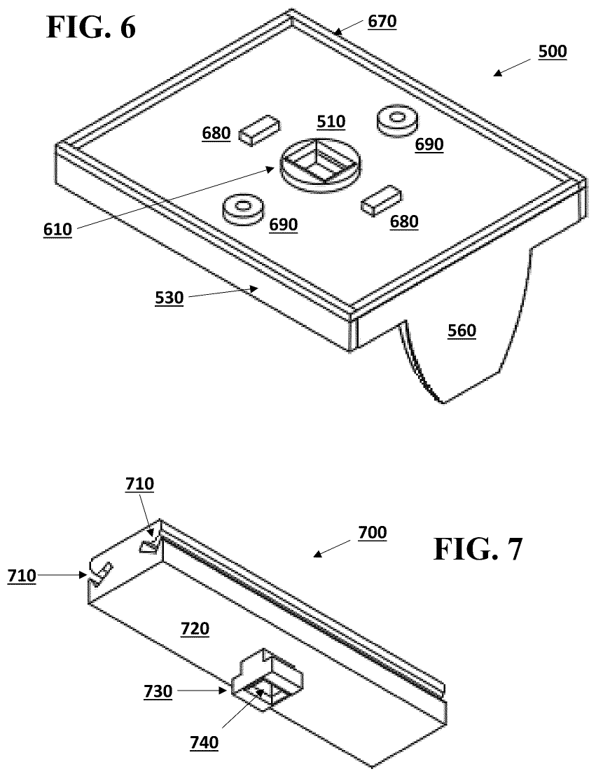

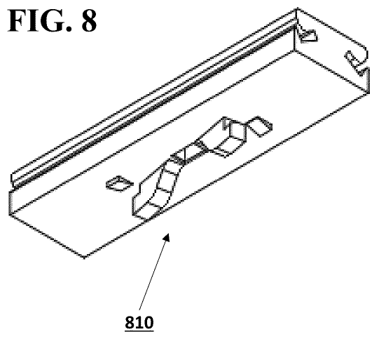

FIG. 3 shows an example fin 300 according to embodiments disclosed herein. The fin 300 has an elongated shape, with a length comparable to the length of the base 200 as shown in FIG. 2 and backplate 500 as shown in FIGS. 5 and 6. In some embodiments, it may be preferred for the backplate length to be slightly longer than length of the fin 300 and/or the base 200. The fin 300 includes three main regions. The upper level 310 contains two separate flat extrusions 315 that are perpendicular to the upper length of the mid level 330. Each extrusion 315 may include an anchoring hole 317 that matches the base 200 and backplate 500. The two extrusions 315 are separate to allow proper connection with the base 200. The upper level 310 is fed through the collinear pair of parallel holes 240 in base 200 as shown in FIG. 2, and overlaid flat with the anchoring holes 230, matching the paired holes on the base. These holes are used in pairs with male extrusions of the backplate 400 as shown in FIGS. 5 and 6, to keep the upper level in place on the base.

The mid level 330 is an elongated shape with no distinct features aside from the upper level 310 perpendicular to the mid level 330, and the lower level 340 perpendicular to the mid level extruding in the opposite direction of the upper level. The mid level 330 is the section of each fin 300 which may flex to prevent damage to the sign and ceiling. The lower level 340 is a single flat extrusion which matches the length of the mid level 330. As previously described, it is perpendicular to the bottom of the mid level 330. The lower level is attached to the sliding mount 700 as shown in and described with respect to FIG. 7.

Typically more than one fin 300 is arranged to enclose the length of the system when fully assembled. The fins may be made from a flexible but resilient material that is capable of substantially or entirely recovering its original shape after being deformed, such as by a person slapping the body of the assembled and installed exit sign. Suitable materials include elastomers, with stiffer elastomer materials permitting lesser deflection of the sign from vertical based on a given force applied to the sign, while less stiff elastomers permit a greater deflection given the same force. Consequently, the stiffer elastomer may cause more force to be transmitted to the ceiling area to which the mount is affixed, while a less stiff elastomer may cause less force to be transmitted, thereby resulting in less damage to the ceiling area. However, an elastomer that is insufficiently stiff may permit the sign to be deflected, for example, over 90 degrees from a vertical position and may allow the sign body to strike the ceiling, which could damage the sign. It may be preferred to use a material with a sufficient stiffness to permit a maximal deflection of the sign without permitting the sign to deflect so much so as to strike the ceiling or another obstacle near the sign, such as another sign, other ceiling fixture, door, or the like. Accordingly, a preferred type of elastomer with a desired flexibility may be selected based on the expected type and/or location of the sign installation.

FIG. 4 shows an example of the conduit component 400. The conduit may be made of a flexible material, such as an elastomer, and includes two main portions. The shaft 410 has an elongated shape with a central hole 415, providing an enclosed area through which wires may feed through the entire system in-pair with corresponding through-holes and channels in the sliding mount 700 (FIG. 7), base 200 (FIG. 2), and backplate 500 (FIGS. 5, 6). The conduit shaft 410 also protects the insulation of the wires if the system swings due to an impact. More generally, the conduit 400 via the conduit shaft 410 also increases the overall resistance of the device to impact, aiding with returning the sign back to its original position.

The shaft is connected to the base 200 so that the central hole 210 aligns with the central hole 415 and the sliding mount 700 shown in FIG. 7 and its central hole 740. The shaft and central holes may have varying wall thicknesses depending on preference. Wider or smaller wall widths may be used to increase or decrease the resistance to movement, respectively. Accordingly, for installations in which less movement is desired, thicker walls may be used, and thinner walls where more movement is required or desired.

The second portion 420 of the conduit includes shaft tabs 430 on either side of the shaft 410. When installed, the tabs 430 are overlaid with the base 200 and align the screw holes on each tab with the matching screw holes 220 on the base 200. The screw holes on the tabs also align with the matching set of holes 550 in the backplate 500 as shown in FIGS. 5-6. Screws or similar connectors thus may secure the conduit in position and relative to the other components when the entire system is installed and in use.

FIGS. 5 and 6 show examples of a backplate according to embodiments disclosed herein. The backplate 500 has the same basic top view profile as the base 200 shown in FIG. 2. FIG. 6 shows an arrangement in which the backplate 500 has a recess on the bottom with extrusions 680, 690. The backplate 500 includes a matching central wiring hole 510 that provides a conduit for electrical wires to be fed through the conduit wire hole 420 and into the slide mount wire hole 740, into a junction box in the ceiling or other mounting location. Matching collinear screw holes 550 allow screws to be fed through, for fastening to the generic ceiling bracket previously disclosed in relation to the base 200. Four male extrusions 520 in the same location as the anchoring holes 230 of the base 200 and anchoring holes 310 of the fins 300. The base 200 with fins 300, fed through the paired holes of the base, is placed flush against the flat portion 501 of the backplate, with male extrusions entering through anchoring holes 317 of the fins 300 and anchoring holes 230 of the base 200. The screws are fed through the screw holes and, when, tightened serve to secure the various components together to prevent unwanted movement.

The backplate 500 may include a perimeter edge 530 that acts as a cover for the base 200. The perimeter 530 also may strengthen the mount in the plane of the flat portion 501 of the backplate 500. Outer side covers 560 may prevent the lower level of the fins 340 from sliding out of the female extrusions 710 of the sliding mount 700 shown in FIG. 7. The outer covers also may guide the sign to swing in a direction parallel to the outer covers 560. This component may be made of a rigid material. In arrangements with back extrusions as shown in FIG. 6, the larger circular extrusion 610 and the two rectangular extrusions 680 allow a metal mounting bracket to fit into the recess and flush with the border 670 of the backplate. Thus, when the mount is installed, there may be trivial or no gap between the ceiling tile and the border of the mount.

FIG. 7 shows a sliding mount 700 according to embodiments disclosed herein. The Sliding Mount 700 has an elongated shape, with largest axis dimension matching the length of the base 200, fins 300, and conduit 400, and fits between them. A matching central hole 740 allows for electrical wiring to be fed to the sign. This hole extends through the depth of the shape and through the universal exit sign clip 730. This clip mimics the male end of the sign-mount connection used by conventional exit signs and similar devices readily available on the market. The sliding mount 700 may include two female extrusions 710 that run the length of the component. These extrusions are used in tandem with the male “T” end of the stem 730 to hold the sign to the mount, while also giving the mount its desired shape. The top flat portion 720 of the sliding mount 700 sits flush with the top of an exit sign.

FIG. 8 shows a second sliding mount 800. The sliding mount 800 attaches in the same manner and functions the same as the example slide mount 700 shown in FIG. 7, but includes an attachment point 810 configured and adapted to connect to different exit sign mounts. More generally, any suitable sign attachment point or mount style may be included on the slide mount 700, 800, without deviating from the scope or content of the present disclosure.

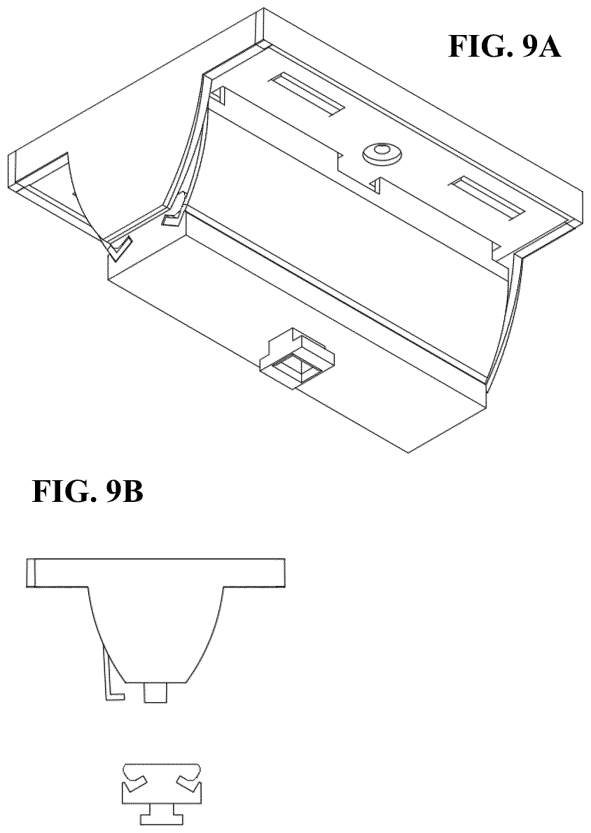

FIGS. 9A and 9B show examples of the assembled mount. The assembled mount system includes fins that bend into place, and the conduit slides into the sliding mount for connection. In some arrangements, the base may be flipped so that there is a slight indent to house the screw. FIG. 9B shows a side view with the sliding mount not yet attached to the rest of the system.

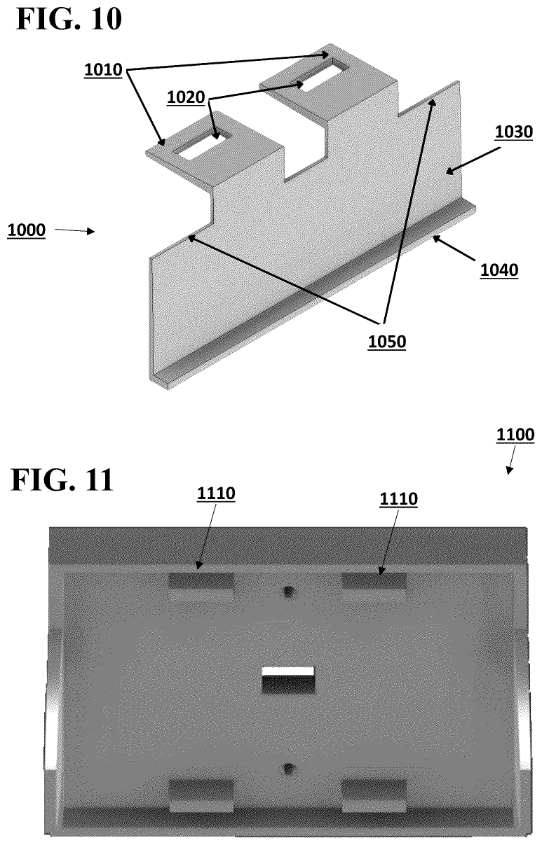

FIG. 10 shows an embodiment of a fin 1000 that may allow the installed system to twist more freely, thus preventing or mitigating some forms of damage resulting from impacts. The fin 1000 has the general geometry as the fin 300 previously described with respect to FIG. 3. The fin 1000 has more narrow tabs 1010 compared to the fins 300, The negative space 1050 on the twisting fin 1000 allows the system to twist more freely, giving it the ability to handle more twisting and torquing motions. The anchor holes 1020 are less wide than in the standard fin 300. This is where the anchor tabs 1110 on the twisting backplate cover 1100 shown in FIG. 11 are paired with the anchor holes 1020 on the twisting fin 1000 as well as the anchor holes on the corresponding base, thus securing the system to itself.

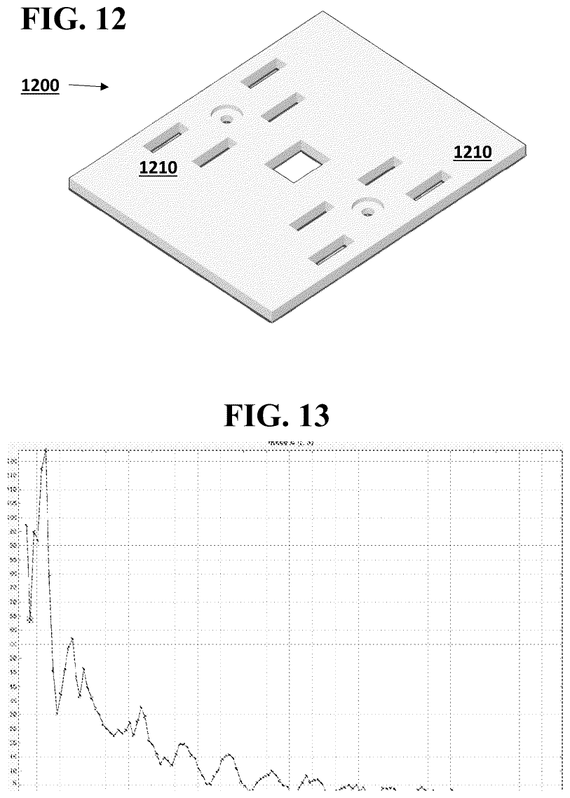

FIG. 11 shows a backplate 1100 that may be used with the twisting fin 1000. This arrangement includes matching anchor tabs 1110 corresponding to the anchor holes 1020 in the twisting fin 1000 and anchor holes 1210 in the twisting backplate 1200 shown in FIG. 12. These anchor tabs secure the system together when screwed into the ceiling and mounting junction box.

FIG. 12 shows a base 1200 that may be used with the twisting fin 1000. Similar to the base 200, matching anchor holes 1210 correspond to anchor holes 1020 in the twisting fin 1000 and anchor tabs 1110 in the twisting backplate 1100. These anchor holes are secured by the anchor tabs to secure the system together when screwed into the ceiling and mounting box.

Embodiments disclosed herein may include fins, such as fins 300, 1000, and/or conduits such as conduit 400, and/or other elements made of elastomer such as thermoplastic polyurethane (TPU) or another such as TPV adapted to deform in response to an external force and then substantially return to their original shapes. For example, if a student slaps the exit sign, the elastomeric elements may temporarily deform, permitting the sign to be temporarily displaced from its normal position to a maximum angle (maximum displacement angle) that relieves the exit sign and ceiling from tension. This can advantageously prevent damage to the sign or the ceiling, the mount or another nearby obstacle. Also, the deformation of the elastomeric elements may help to absorb and dissipate at least some of the energy of the strike, thereby reducing or preventing damage to the mounting system and the exit sign. The deformed elastomeric elements exert a restorative force that causes the sign to substantially return to its original position. An example of a suitable elastomeric material is TPV with a Shore hardness of 70a-80a. The Shore hardness to use will depend on the mass of the sign, its dimensions, design, rigidity and robustness, as well as the desired maximum displacement of the sign. For example, a lower Shore hardness would permit a greater degree of displacement of the sign after an impact, which may cause the sign to strike the ceiling too hard. In that case, the Shore hardness of the elastomer should be increased at least until the desired maximum displacement angle is the most the sign will deflect from its normal position as a result of an impact having an expected impact. Likewise, an elastomer with a higher Shore hardness may reduce the maximum angle of deflection, but transmit too much force through the rest of the mount so as to cause damage to the ceiling or other cause the sign to fail under the impact. In that case, an elastomer with a lower Shore hardness should be used. For most signs, an elastomer with a Shore hardness in the range of 70a-80a is acceptable. More generally, it has been found that elastomers with Shore hardness in the range of 50-69, 70-80, or 81-95 are suitable for use in the embodiments disclosed herein, depending on the particular application and installation requirements, following these guidelines. These materials and hardness ranges provide a suitable degree of flexibility to prevent damage to the sign, the mount, and the surrounding installation location as described above. In various embodiments, it may be preferred for only the fin, only the conduit, or both the fin and the conduit to be made of the elastomer, depending on the same installation requirements.

In accordance with embodiments disclosed herein, a maximum displacement angle may be less than 90 degrees from vertical to prevent damage to the surface to which the sign is mounted and to the sign itself that would be caused by a collision with the mounting surface by the sign.

Given the range of energy that can be imparted to the sign system by, say, a student hitting the sign, embodiments of the present invention can be designed to enforce an average maximum displacement angle of 65-80 degrees to provide a margin of error and prevent the sign from colliding with the mounting surface. In embodiments less tolerant of sign displacement, the maximum displacement angle can be limited to 35-65 degrees by making the elastomeric elements stiffer (e.g., have a higher Shore hardness). In constrained environments, or environments in which the force or impulse applied to the sign is expected to be smaller, embodiments can use elastomeric elements having a lower Shore hardness (for example, 40a-65a) to enforce the maximum displacement angle. In certain environments, the maximum displacement angle may not be important and collision with the mounting surface or the ceiling may not be a concern. In any event, the displacement angle can be up to (or greater than with low Shore hardness) 90 degrees.

Embodiments with stiffer elastomeric elements can restore the sign to substantially its normal, typically vertical operating position or thereabouts in between about 0.2 seconds to about 0.8 seconds measured from the time of the strike to the earliest time the sign substantially returns to about its original position. A sign substantially returns about to its original position when it comes to rest no more than around 12 degrees, preferably no more than 8 degrees, and more preferably no more than 4 degrees from its original operating position (e.g., vertical).

Embodiments with mid-range Shore hardness can substantially restore the sign to its original position in about 0.5 to about 1.1 seconds. A sign with elastomeric elements having still lower Shore hardnesses can substantially restore the sign to around its original position in 1.1 to two seconds. When time it takes to restore the sign to its original is not of the essence, elastomeric elements with still lower Shore hardnesses can substantially restore the sign to about its original position in 2 to five seconds.

Various embodiments may prevent a sign from rebounding more than 50% of its initial displacement in response to a shock, and in some embodiments less than 30% from its initial displacement.

Embodiments of an exit sign and mounting canopy disclosed herein may provide advantages and benefits such as the following, in comparison to conventional sign mounts and similar systems:
Longer life span in high risk environments
Longer life span in low risk environments
Simplified and less-expensive installation and replacement
Reduced frequency of replacement
Improved safety in high schools, college dorms, and other high abuse areas

In addition, embodiments disclosed herein may be used universally with most signs and as a replacement for current mounts. Use of mounting systems as disclosed herein also may reduce or prevent faceplate destruction, thus conserving resources for institutions faced with regular maintenance.

### EXPERIMENTAL

In operation, embodiments disclosed herein may, upon being struck, be deflected between 0 and 89 degrees from their normal vertical operating position and then return to within 8 degrees of vertical within 1 second and continue to function properly. To test this property, exit signs were attached to mounting systems as disclosed herein and subjected to strikes as would be expected during normal use.

FIG. 13 shows the displacement from vertical experienced by a sign after being struck by an adult with respect to time. It can be seen that the sign returns to vertical relatively quickly, typically less than one second.

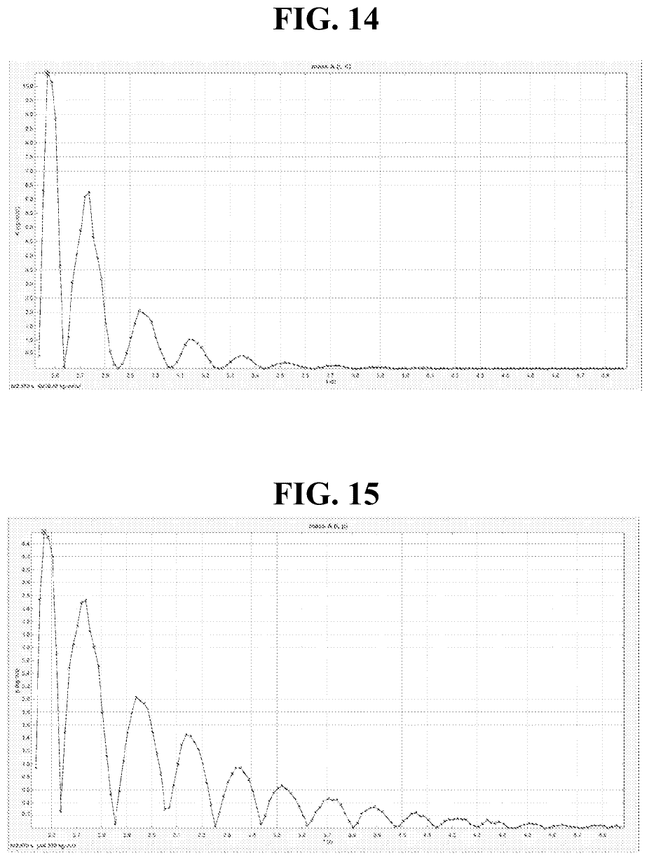

FIG. 14 shows the acceleration of the sign in response to a slap by a student. Acceleration is shown in m/s2 and on the y-axis vs. time in seconds on the x-axis. As can be seen from the chart, the acceleration experienced by an embodiment of the present invention peaked around 125 m/s2 and then rapidly decreased to about 30 m/s2 before rebounding to only about 57 m/s2, before being further dampened, without breaking the sign or its mounting. Peak KE measured is 10.48 J.

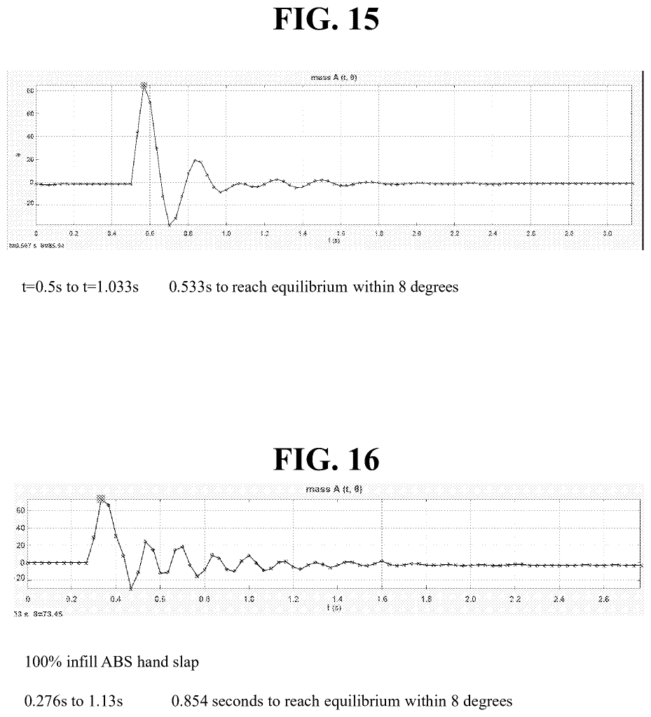

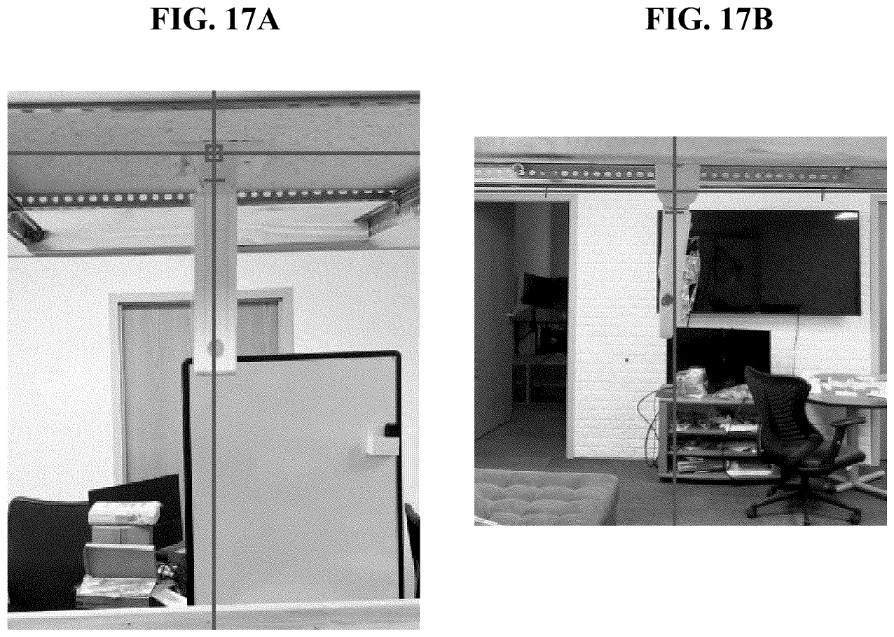

FIG. 15 shows the magnitude of the momentum of the sign in response to a slap by a student. Magnitude is in kg-m/s2 and is shown on the y-axis vs. time in seconds on the x-axis. As can be seen from the chart, the momentum experienced by an embodiment of the present invention peaked around 4.578 kg*m/s2 and then dampened significantly over the first 5 seconds, without breaking the sign or its mounting. The strike duration was 0.033 seconds from t=2.537 to t=2.570 s. The impulse obtained from the change in momentum from t=2.537 to t=2.570 which is 4.578-0.939=3.639. The test was performed with PLA 15% infill. The maximum deflection appears to be 90 degrees from normal as expected. FIGS. 16-17 show deflection angle vs time for the strike, and are considered at equilibrium once they are oscillating within 8 degrees of the normal.

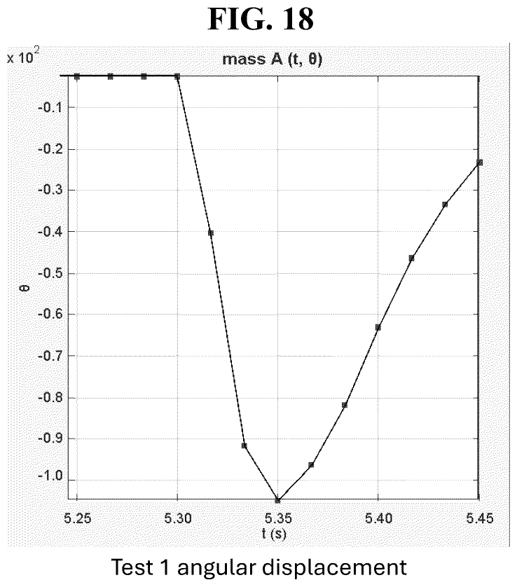

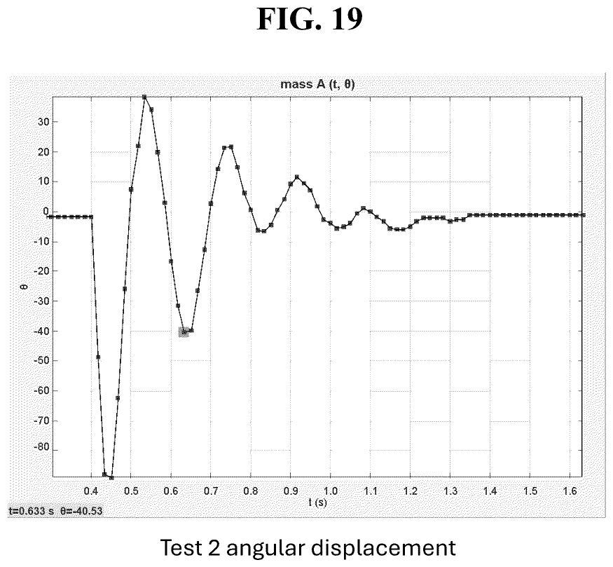

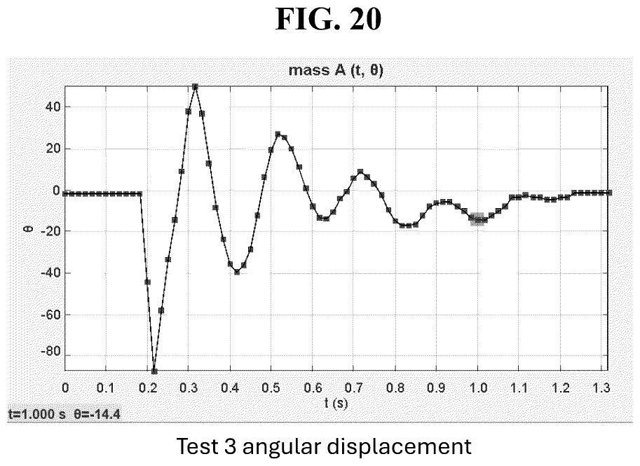

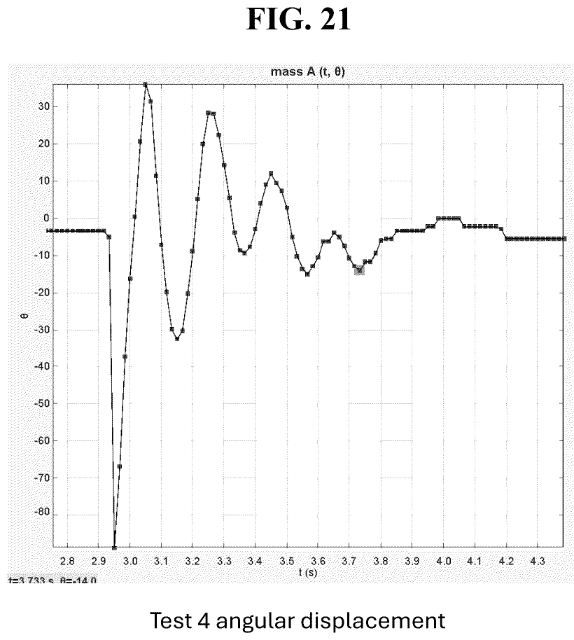

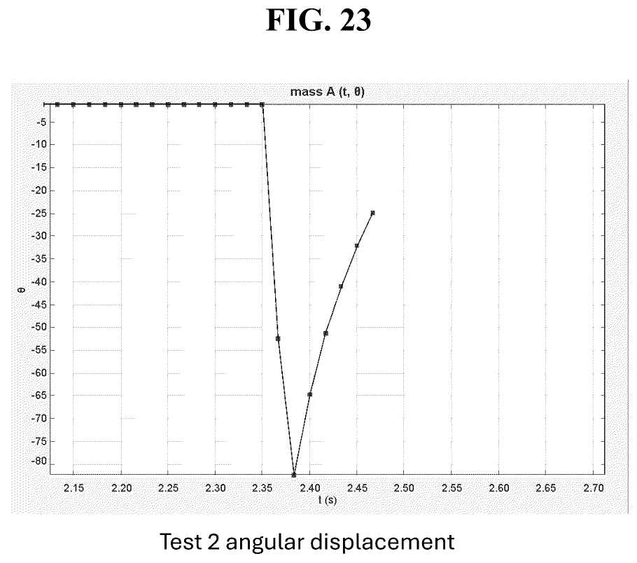

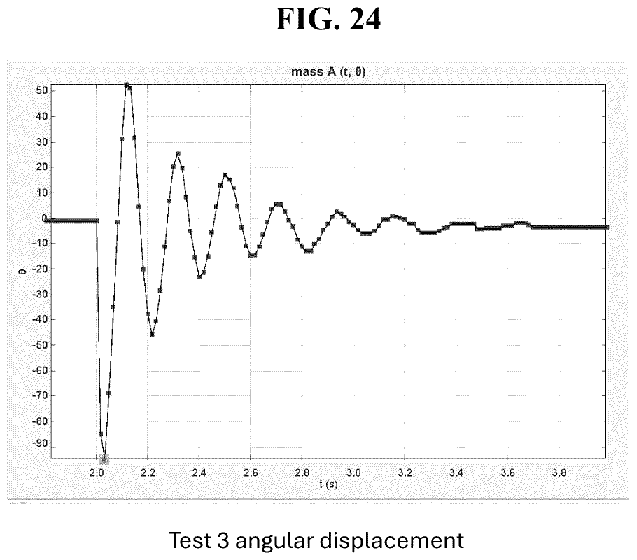

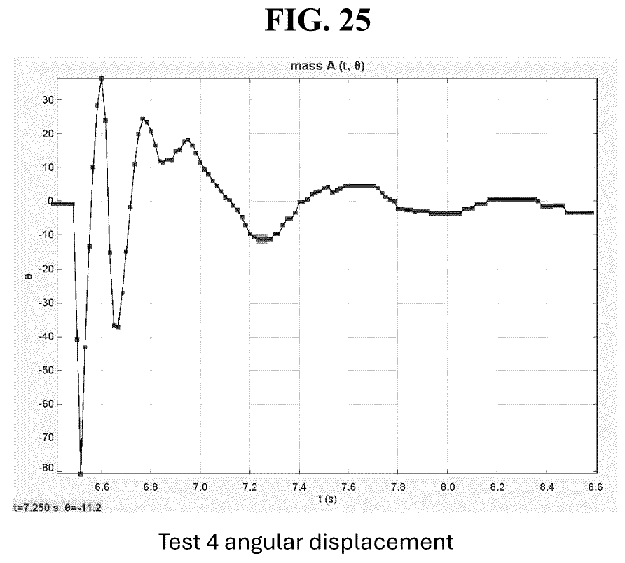

Tests were also performed to compare a sign mount as disclosed herein (“ESS mount”) to a “swinging” mount available in the market (“Swing mount”). FIGS. 17A-17B show the experimental setup. The following testing conditions and assumptions were used for multiple tests with the ESS mount:
Test subject: male 83.9 kg with 0.2 kg boxing glove
Injection molded fins, backplate, and base
Slide mount: 70% infill polymaker ABS (3D printed)
Conduit: Colorfabb Varishore TPU 15% infill (3D printed)
Sign mass with transformer battery and accelerometer rig: 0.889 kg
1-2 inches of transformer slack from sign transformer to opening in sign
ADAfruit ADXL375 accelerometer used to measure max acceleration (ax max, ay max, az max)·
Accelerometer was placed inside of the sign.
Test subject punched sign from back panel perpendicular to surface of sign
Tracker physics software was used to measure angular displacement and equilibrium return time based on tracking a point on the edge of the sign.
Swing radius rswing-sign length+effective length of mount=0.231 m
Angular acceleration measured is with respect to plane parallel to ceiling where swinging access is located as shown in FIG. 17A

$$\begin{matrix}{a}_{netmax} = \sqrt{{( {a}_{x max} )}^{2} + {( {a}_{y max} )}^{2} + {( {a}_{z max} )}^{2}} \\ {P}_{applied} = {a}_{netmax} * {m}_{sign} \\ {a}_{tangential m ax} = \sqrt{{( {a}_{y max} )}^{2} + {( {a}_{z max} )}^{2}} \\ {α}_{sign} ( angular acceleration ) = \frac{{a}_{tangential m ax}}{{r}_{swing}} \\ Logarithmic decrement : δ = \frac{1}{n} ln ( \frac{x ( t )}{x ( t + Tn )} ) \\ Dampening ratio : ξ = \frac{δ}{\sqrt{4 {π}^{2} + {δ}^{2}}}\end{matrix}$$

where n is the number of positive peaks from start of motion until peak before sign is below 8 degrees from FIGS. 18-26.

The following testing conditions and assumptions were used for multiple tests with the Swing mount:
Test subject: male 83.9 kg with 0.2 kg boxing glove
Length of sign=0.2286 m
Weight: approximately 2.33 kg
Circuitry and battery on outside of sign when tested. Wires were not fed through sign.
ADAfruit ADXL375 accelerometer used to measure max acceleration
Test subject punched sign from back panel perpendicular to surface of sign
Swing radius rswing=sign length+effective length of mount=0.229 m
Sign rotates up to 70 degrees one direction and 90 the other. Sign was impacted in direction in which sign reaches 90 degrees.
Tracker physics software used to measure angular displacement and equilibrium return time based on tracking a point on an edge of the sign. The accelerometer was placed on side of sign that swings 90 degrees of the sign.

FIGS. 18-26 show the angular displacement of a test sign over time. The angular displacement curves in FIGS. 18-26 from normal only measure how much sign was displaced relative to the coordinate system. The maximum angular displacement measurements were measure with respect to the mount. The coordinate system was adjusted to account for shifting of test rig in video to measure max angular displacement. Return to equilibrium time was defined as the time it takes sign to return to within 8 degrees of normal.

FIGS. 18-21 show angular displacement over time for the ESS mount with a 0.061 in conduit.

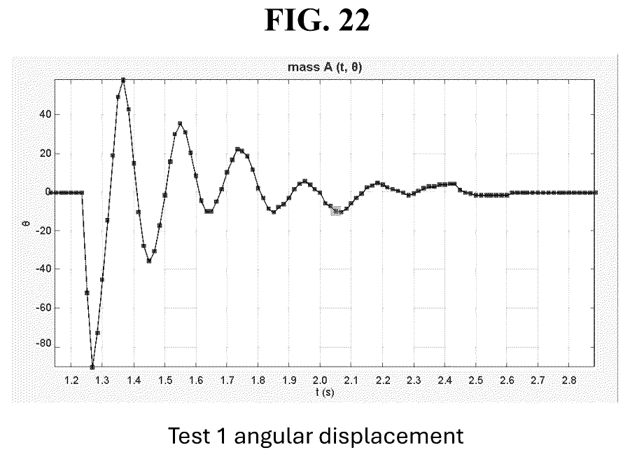

FIGS. 22-25 show angular displacement over time for the ESS mount with a 0.071 in conduit.

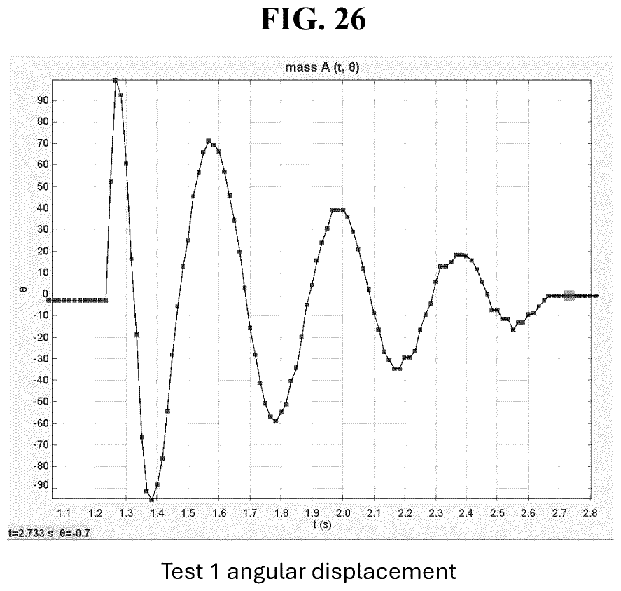

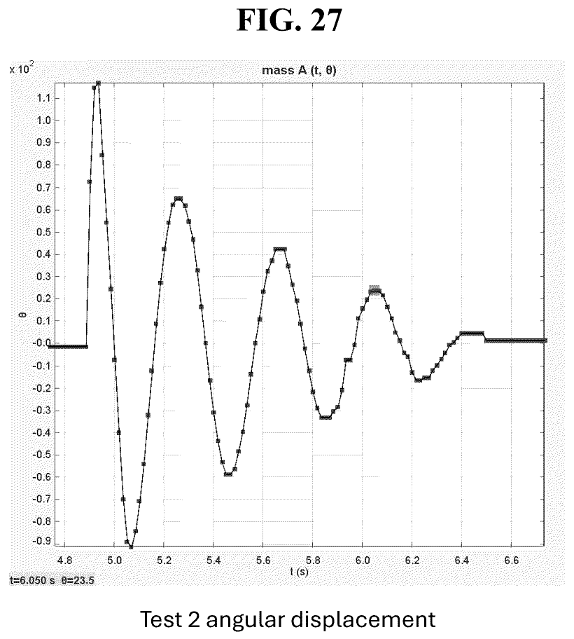

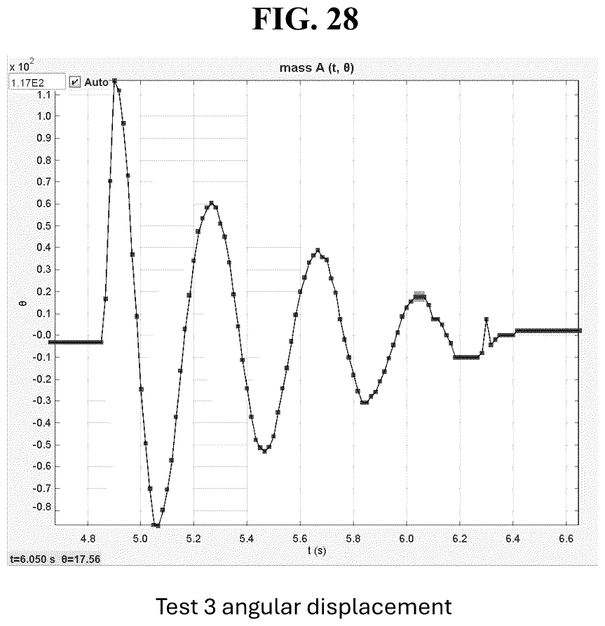

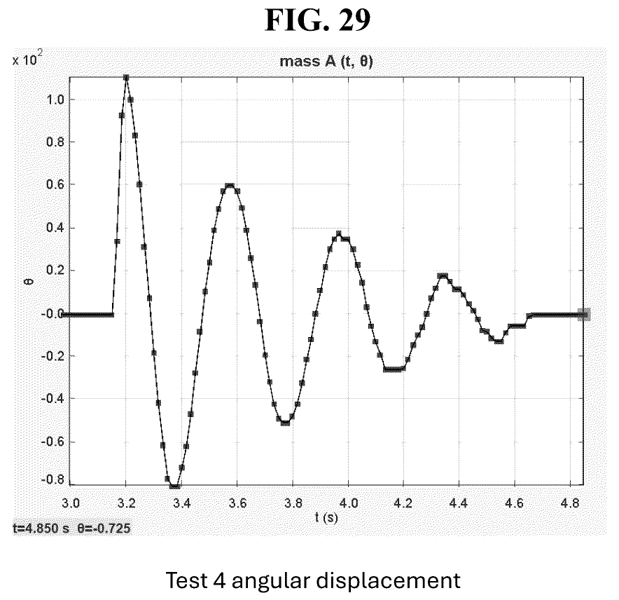

FIGS. 26-29 show angular displacement over time for the Swing mount.

The following results were obtained for the ESS and Swing mounts:

### ESS Mount

Withstands (i.e., survives with negligible, trivial, or no damage) at least 829 Newtons of force to the back of the sign if the conduit thickness is 0.061 in.
Withstands at least 919 Newtons to the back of the sign if the conduit thickness is 0.071 in
Deflects no more than 90 degrees for both 0.061 in and 0.071 in thick conduits with respect to mount.
The time it takes for mount to return to within 8 degrees (from normal) to stationary position is less than 1 second
Withstands tangential acceleration of at least 1031 m/s² if conduit is 0.071 in thick
Withstands tangential acceleration of at least 954 m/s² if conduit is 0.061 in thick
Withstands angular acceleration of at least 4135 rad/s² if conduit is 0.061 in thick
Withstands can handle angular acceleration of at least 4465 rad/s² if conduit is 0.071 in thick
Dampening Ratio between 3 trials 0.061 in conduit:0.0594 average
Dampening Ratio between 3 trials 0.071 in conduit:0.0701 average
Thicker conduit increases dampening ratio.

### Swing Mount

Withstands at least 3042 N of force to the back of the sign in the direction that the sign can swing freely up to 90 degrees.
Motion of sign constrained primarily to the direction of impact thus linear acceleration upwards
Motion of sign is more stable compared to ESS mount and wobbles less
Mount returns to within 8 degrees from normal to a stationary position is less than 1.4 s at maximum impact
Withstands angular acceleration up to at least 5703 rad/s²

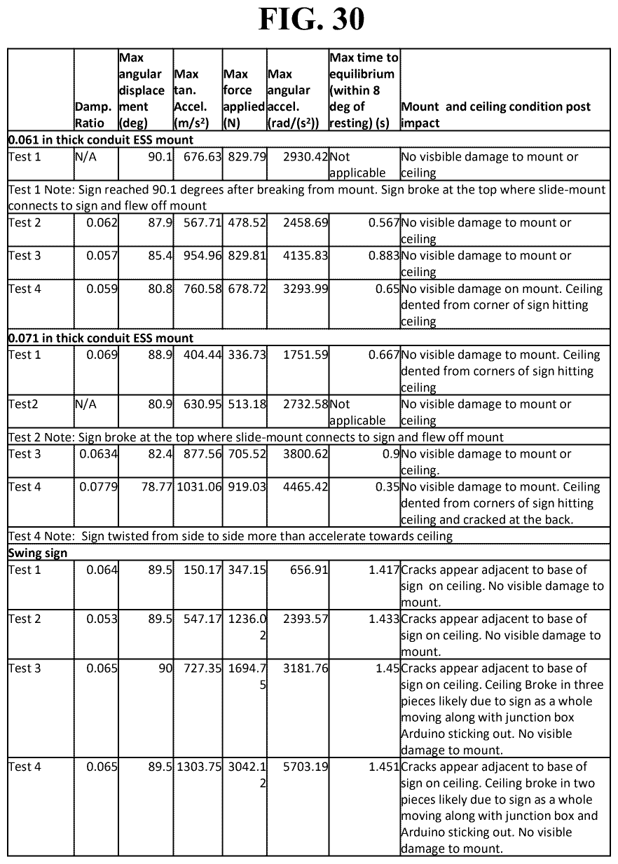

FIG. 30 shows results of the tests performed on two versions of the ESS mount and the Swing mount. Overall, it was found that the Swing mount has a higher dampening ratio than the ESS mount. However, the time to return to equilibrium position of ESS mount is less than that of Swing Mount. It is believed that the time to return to equilibrium position is a better measure of dampening due to the motion tracking software not being able to account for the dampening due to torsion or other movements of mount.

Notably, in all tests of the Swing sign arrangement, the mount moved such that the sign moved more than 90 degrees with respect to the ceiling and hit the ceiling with the testing circuit, although the sign moved a maximum of 90 degrees with respect to the mount and there was no visible damage on the sign and/or mount. In most installations, this type and degree of damage likely would require removal and replacement of the associated ceiling portion, such as a damaged ceiling tile in a drop ceiling. This is often more complex and/or costly than replacing the sign itself. In contrast, embodiments disclosed herein include elastomeric components as previously disclosed that prevent such damage by gradually reducing the force transmitted through the sign and/or mount instead of swinging and hitting a “stop,” which then jars the entire sign into the ceiling. The features of embodiments disclosed herein that prevent such damage to the ceiling or ceiling tiles may be particularly beneficial in installations where the ceiling should remain intact to protect electrical lines, isolate fire, dampen sound, and the like.

While the above description includes several example implementations, the invention is not limited to the implementations described and can be practiced with modification and alteration within the spirit and scope of the appended claims. The description is thus illustrative instead of limiting. Further, references in the specification to “one implementation,” “an implementation,” “an example implementation,” and the like indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

1. An apparatus comprising:
a backplate arranged and configured to be fixed to a surface and having a backplate aperture to permit electrical wires to pass therethrough;
a base plate arranged and configured to be fixed to the backplate, the base plate having a base plate aperture to permit electrical wires to pass therethrough that aligns with the backplate aperture when the base plate is fixed to the backplate;
a fin having a first surface arranged and configured to be fixed between the backplate and the base plate and a second surface having a proximal edge at which it is connected to the first surface and a distal edge, the second surface disposed at an angle of at least 45 degrees to the first surface;
a sliding mount arranged and configured to slidably connect to the distal edge of the fin; and
a wire conduit for conducting an electrical wire through the backplate aperture and the base plate aperture.

2. The apparatus of claim 1, wherein the fin comprises a flexible material for dampening the effect of an impact to the apparatus.

3. The apparatus of claim 1, wherein the fin, the conduit, or a combination thereof comprises an elastomer having a Shore hardness of 70-80.

4. The apparatus of claim 1, wherein the fin, the conduit, or a combination thereof comprises an elastomer having a Shore hardness of 50-69.

5. The apparatus of claim 1, wherein the fin, the conduit, or a combination thereof comprises an elastomer having a Shore hardness of 81-95.

6. The apparatus of claim 1, wherein the fin comprises an elastomer having a Shore hardness of 50-95.

7. The apparatus of claim 1, wherein the conduit comprises an elastomer having a Shore hardness of 50-95.

8. The apparatus of claim 1, wherein the sliding mount comprises a fastener arranged and configured to receive an exit sign.

9. A sign mount comprising one or more components comprising an elastomeric material arranged and configured to deform in response to an impact to a sign connected to the mount, wherein deformation of the elastomeric material generates a force opposing and dampening effects of the impact.

10. The sign mount of claim 9, wherein sign returns to a position within 8 degrees of an original vertical position in not more than one second after the impact.

11. The sign mount of claim 9, wherein, when the mount is fixed to a ceiling, deformation of the elastomer prevents damage to the ceiling resulting from displacement of the sign in response to the impact.
